(19) United States
(12) Patent Application Publication
(10) Pub. No.: US 2009/0218905 A1
(43) Pub. Date: Sep. 3, 2009

(54) COIL FIXING MEMBER AND ELECTRIC ROTARY MACHINE

(75) Inventors: Hiroshi Kaneiwa, Chiryu-shi (JP); Shinji Kouda, Kariya-shi (JP); Shinichi Ogawa, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/393,167

(22) Filed: Feb. 26, 2009

(30) Foreign Application Priority Data
Feb. 29, 2008 (JP) 2008-049922

(51) Int. Cl. H02K 3/48

(52) U.S. Cl. 310/214

(57) ABSTRACT

Coil fixing members are placed between a stator coil and at least one end surface of a stator core in an electric rotary machine in order to suppress a displacement between the stator core and the stator coil. Each coil fixing member has primary and secondary fixing members. The primary fixing member has a wedge-plate shape having a support part at one side of the circumferential direction of the stator core. The support part supports the connection part of the winding of the stator core. The primary fixing member is inserted from the inner side of the diameter direction of the stator core toward the outer side thereof between the connection parts of the windings of the stator coil and the end surface of the stator core. The secondary fixing member has a rod shape placed at the other side of the primary fixing member.

### CROSS-REFERENCE TO RELATED APPLICATION

This application is related to and claims priority from Japanese Patent Application No. 2008-49922 filed on Feb. 29, 2008, the contents of which are hereby incorporated by reference.

### BACKGROUND OF THE INVENTION

1. Field of the invention

The present invention relates to coil fixing members capable of suppressing a displacement between the stator core and the stator coil of an electric rotary machine, and also relates to electric rotary machines having the stator core, the stator coil, and one or more coil fixing members assembled between the stator core and the stator coil.

2. Description of the Related Art

Recently, there is a strong demand to provide electric rotary machines such as electric motors and alternators with an improved quality, a high electric power, and a small size. For example, the electric rotary machine with a high electric power is assembled in the engine compartment. The area of the engine compartment of the vehicle tends to be reduced according to the above recent demand. Thus, there is the strong demand to improve the reliability of the electric rotary machine.

Japanese patent laid open publication No. JP 2000-166158 has disclosed a conventional technique of the electric rotary machine equipped with insulation spacers. Those insulation spacers are placed between the stator core and the stator coil of the electric rotary machine. However, those insulation spacers are only placed between them in the electric rotary machine without being supported by the stator core and the stator coil. This conventional structure of the electric rotary machine often causes shifting of the insulation spacers between the stator core and the stator coil. The insulation spacers finally fall away or release from the stator core by vibration, thermal stress, or mechanical stress caused when the electric rotary machine is rotating.

Falling away of the insulation spacers from the stator core causes the electrical contact between the stator core and the stator coil. This causes the deterioration of the insulating function of the stator winding wound on the stator core. The deterioration of the stator winding and the stress by the vibration causes damage to the stator winding. As a result, the damage to the stator core reduces the reliability of the electric rotary machine.

### SUMMARY OF THE INVENTION

It is an object of the present invention to provide coil fixing members, and an electric rotary machine with the coil fixing members. In particular, each coil fixing member, to be placed between the stator coil and the stator core of the electric rotary machine, is hard to slip or shift, and finally fall away from the stator core.

To achieve the above purposes, the present invention provides a coil fixing member to be inserted and placed between a stator coil and at least one end surface of a stator core in an electric rotary machine having a rotor with a plurality of magnetic north and south poles alternately placed along the circumferential direction thereof. Each coil fixing member suppresses a displacement between the stator core and the stator coil and fixing them together. The stator core has a plurality of slots formed along the circumferential direction of the stator core. The direction in depth of each slot is equal to the diameter direction of the stator core. The slots face together at the inside or the outside. The stator coil has stator windings. Each stator winding has connection parts. Each connection part connects the stator windings in slot accommodation parts together at the outside of the slots. The slot accommodation parts are placed in different slots in the circumferential direction of the stator core. Each coil fixing member has a primary fixing member and a secondary fixing member. The primary fixing member has a wedge-plate shape and has a support part at one side of the circumferential direction of the stator core. The primary fixing member is inserted from the outer side of the diameter direction of the stator core toward the inner side thereof between the end surface of the stator core and the connection parts of the windings of the stator coil. The support part is capable of supporting the connection part of the winding of the stator core. The secondary fixing member of a rod shape is placed at the other side of the primary fixing member. The secondary fixing member is inserted from the inner side of the diameter direction of the stator core toward the outer side thereof between the connection parts of the windings of the stator coil and the end surface of the stator core.

The coil fixing member according to the present invention is composed of the primary fixing member and the secondary fixing member which are inserted respectively from opposite directions in the diameter direction of the stator core. The structure of the coil fixing member suppresses the first fixing member and the second fixing member from shifting to each other. One or more coil fixing members are placed between the stator coil and the stator core in order to also suppress the stator coil from shifting to the stator core. This structure prevents the coil fixing members placed between the stator coil from falling away from the stator coil and the stator core in the electric rotary machine even if vibration, heat energy, and mechanical stress are applied to the electric rotary machine. Therefore assembling the coil fixing members according to the present invention into the electric rotary machine suppresses deterioration of the function of the electric rotary machine.

### BRIEF DESCRIPTION OF THE DRAWINGS

A preferred, non-limiting embodiment of the present invention will be described by way of example with reference to the accompanying drawings, in which:

FIG. 1 is a perspective view of the structure of a coil fixing member to be assembled into the stator coil and the stator core of an electric rotary machine according to the embodiment of the present invention;

FIG. 2 is a perspective view of a primary fixing member of the coil fixing member according to the embodiment of the present invention;

FIG. 3 is a perspective view of a secondary fixing member of the coil fixing member according to the embodiment of the present invention;

FIG. 4 is an enlarged view of an assembled state of the stator coil and the stator core in the electric rotary machine according to the embodiment of the present invention;

FIG. 5 is an enlarged view of an assembled state of the primary coil fixing member in the coil fixing member between the stator coil and the stator core of the electric rotary machine according to the embodiment of the present invention;

FIG. 6 is an enlarged view of an assembled state of the primary coil fixing member and the secondary coil fixing member of the coil fixing member between the stator coil and the stator core in the electric rotary machine according to the embodiment of the present invention;

FIG. 7 is a cross section of the electric rotary machine to which the coil fixing members according to the embodiment of the present invention are assembled;

FIG. 8A and FIG. 8B each shows a cross section of each phase winding that forms the stator coil of the electric rotary machine according to the embodiment of the present invention; and

FIG. 9 is a view showing a star connection (Y-connection) of three phase (U, V, and W phases) windings in the electric rotary machine according to the embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiment

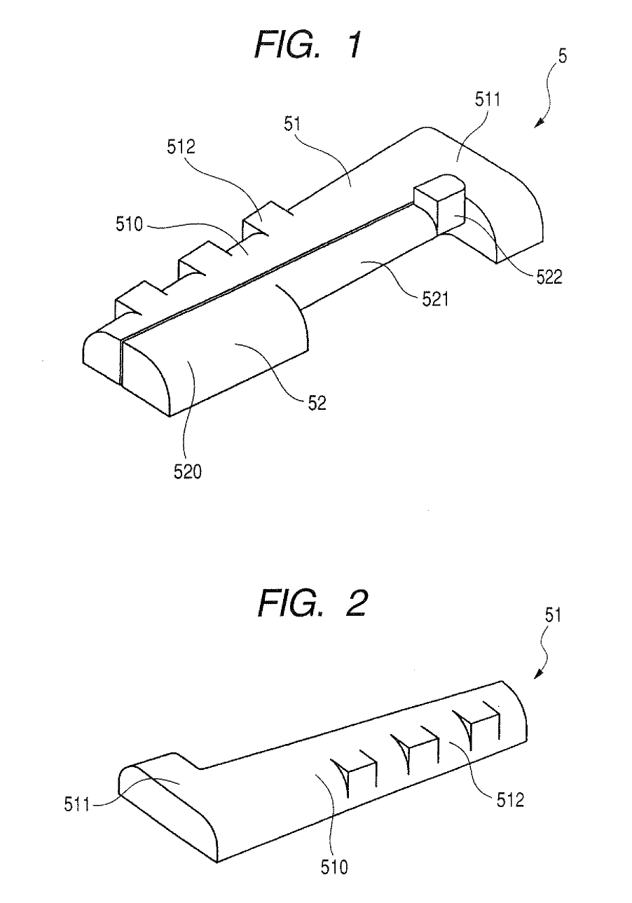

A description will be given of the coil fixing member according to an embodiment of the present invention with reference to FIG. 1 to FIG. 9.

The coil fixing members according to the embodiment of the present invention are applied to the electric rotary machine 1 with the rotor 2 and the stator 3. The stator 3 has the stator coil 4 and the stator core 30.

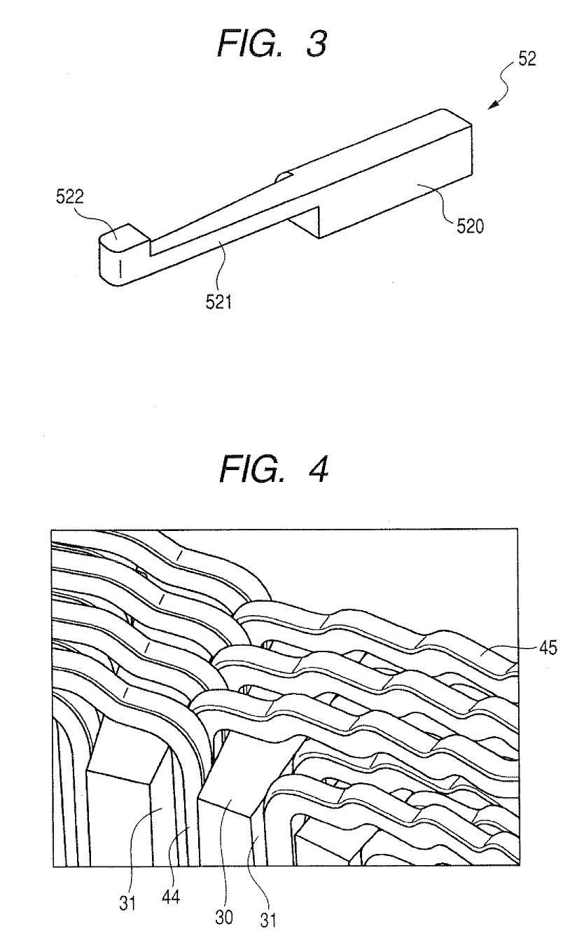

FIG. 1 is a perspective view of a structure of the coil fixing member 5 to be assembled between the stator coil 4 and the stator core 30 of an electric rotary machine 1 according to the embodiment of the present invention. FIG. 2 is a perspective view of a primary fixing member 51 of the coil fixing member 5 according to the embodiment. FIG. 3 is a perspective view of a secondary fixing member 52 of the coil fixing member 5 according to the embodiment. As shown in FIG. 1 to FIG. 3, the coil fixing member 5 is comprised of the primary coil fixing member 51 and the secondary coil fixing member 52.

The surface of each corner of the primary coil fixing member 51 and the secondary coil fixing member 52, which is the opposite side to the stator core 30 when it is placed between the stator coil 4 and the stator core 30, has a smoothly tapered and rounded shape.

As shown in FIG. 2, the primary coil fixing member 51 is composed of a main body part 510 of a wedge-plate shape and a stopper part 511. The main body part 510 and the stopper part 511 are assembled together. The stopper part 511 is formed at an end part of the main body part 510 of the wedge shape. Thus, the stopper part 511 projects toward a wide direction of the main body part 511.

A support part 512 is formed at the side surface of the main body part 510 in the wide direction thereof. The support part 512 supports the windings 40 forming connection parts 45 of the stator coil 4. The support part 512 is the surface of the main body part 510 and has concave and convex parts which approximately correspond to the windings 40 which form the connection parts 45.

As shown in FIG. 3, the primary coil fixing member 51 is a bar member composed of a base end part 520, a thin thickness part 521, and a claw part (or a lock part) 522.

The base end part 520 is a member, the cross section of which has a fan shape. The base end part 520 is to be placed at the inner side of the diameter direction of the stator core 30 between the stator coil 4 and the stator core 30.

The thin thickness part 521 and the base end part 520 are assembled together. The thin thickness part 521 is a plate member extending from the base end part 520 toward the diameter direction of the stator core 30. The thin thickness part 521 is to be placed to form a gap between the thin thickness part 521 and the end surface of the stator core 30.

The claw part 522 is formed at the front end part of the thin thickness part 521 to project toward the opposite direction of the stator core 30. The claw part 522 is contacted with the connection part 45 of the winding 40 of the stator coil 4 when the secondary coil fixing member 52 is placed between the stator coil 4 and the stator core 30. The claw part 522 is locked by the connection part 45 of the winding 40 of the stator coil 4. This structure prevents the secondary coil fixing member 52 from releasing and falling away toward the diameter direction of the stator core 30.

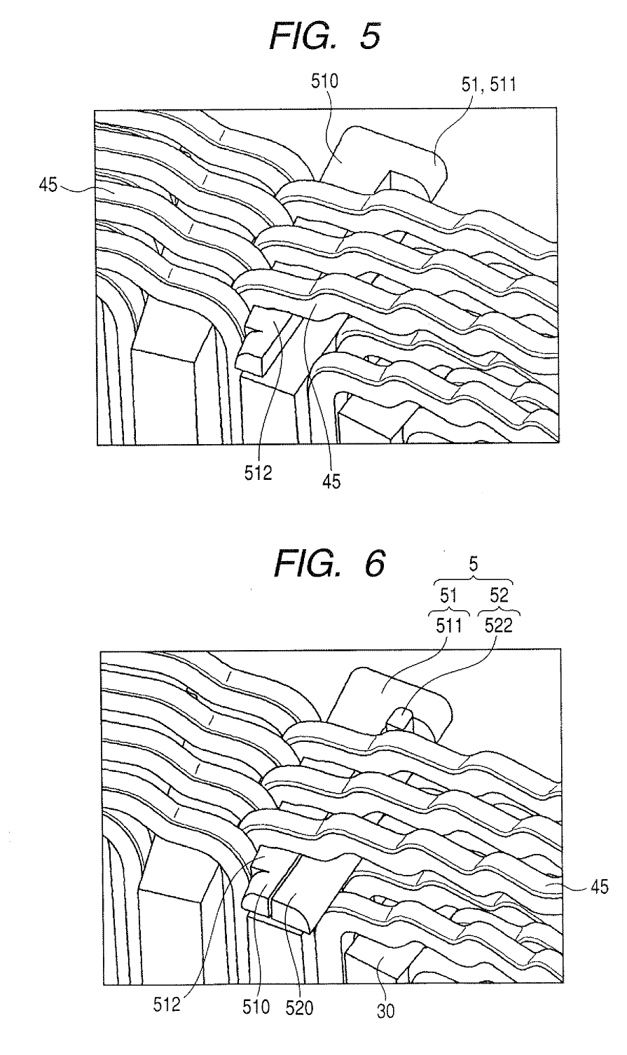

FIG. 4 is an enlarged view of an assembled state of the stator coil 4 and the stator core 30 in the electric rotary machine 1 according to the embodiment of the present invention. FIG. 5 is an enlarged view of an assembled state of the primary coil fixing member 51 in the coil fixing member 5 between the stator coil 4 and the stator core 30 of the electric rotary machine 1 according to the embodiment of the present invention. FIG. 6 is an enlarged view of an assembled state of the primary coil fixing member 51 and the secondary coil fixing member 52 of the coil fixing member 5 between the stator coil 4 and the stator core 30 in the electric rotary machine 1 according to the embodiment of the present invention.

As shown in FIG. 47 the coil fixing member 5 of the embodiment is used as a fixing member to be inserted into a gap between the end surface of the stator core 30 and the connection parts 45 of the windings 40 of the stator coil 4.

That is, the primary coil fixing member 51 is inserted from the outside of the diameter direction toward the inside thereof into the gap between the end surface of the stator core 30 and the connection parts 45 of the windings 40 of the stator coil 4. This insertion of the primary coil fixing member 51 is performed so that the primary coil fixing member 51 is inserted into a central part between a pair of slots 31 shown in FIG. 4.

When the primary coil fixing member 51 is correctly placed at a predetermined position between the connection parts 45 and the stator coil 30, the primary coil fixing member 51 is shifted toward the other side of the wide direction of the main body part 510 in order to engage it with the connection parts 45 of the winding 40 of the stator coil 4.

As shown in FIG. 5, after the support part 512 engages with the connection parts 45, the primary coil fixing member 51 is fixed in the gap formed between the connection parts 45 of the windings 40 of the stator coil 4 and the stator core 30. This structure limits the windings 40 with the connection parts 45 contacted with the support part 512 of the main body part 510 to shift toward the axial direction of the stator core 30

After the above assembling of the primary coil fixing member 51 into the connection parts 45 and the stator core 30, the secondary coil fixing member 52 is inserted, from the inside of the diameter direction of the stator core 30 toward the outside thereof into the gap between the connection parts 45 of the windings 40 of the stator core 4 and the end surface of the stator core 30 at the one side of the main body part 510 of the primary coil fixing member 51. When the secondary coil fixing member 52 is inserted into this gap, the front end part of the thin thickness part 521 is bent toward the direction of the stator coil 30, and the claw part 522 is pushed, so that the claw part 522 does not influence the connection parts 45 of the windings 40 of the stator coil 4 when the secondary coil fixing member 52 is inserted into the gap.

After the secondary coil fixing member 52 is inserted into the gap, when the claw part 522 reaches to the outer periphery side of the stator core 30 in the diameter direction of the stator core 30, the thin thickness part 521 of the secondary coil fixing member 52, which is bent toward the direction of the stator core 30 side, is returned to its original shape, namely, to the plate shape from the bent shape. The position of the claw part 522 in the axial direction of the stator core 30 overlaps the connection part 45 of the winding 40 of the stator coil 4, and the claw part 522 is locked by the connection part 45 shown in FIG. 6. At this time, the side surface of the claw part 522 is contacted with the outer periphery of the connection part 45. As a result, the secondary coil fixing member 52 does not shift toward the diameter direction of the stator core 30 because the claw part 522 is locked by the connection part 45 of the winding 40 of the stator coil 4.

Because the stopper part 511 of the primary coil fixing member 51 is positioned at the outside of the inserted secondary coil fixing member 52 toward the diameter direction of the stator core 30, the primary coil fixing member 51 limits the secondary coil fixing member 52 to shift toward the outside of the diameter direction of the stator core 30.

As shown in FIG. 6, the main body part 510 of the primary coil fixing member 51 and the base end part 520 of the secondary coil fixing member 52 limit the connection parts 45 of the windings 40 of the stator coil 4 to shift toward the circumferential direction of the stator coil 4.

As a result, the coil fixing member 5 according to the embodiment of the present invention avoids the drawback caused by the presence of the gap formed between the connection parts 45 of the windings 40 of the stator coil 4 and the end surface of the stator core 30, and to tightly fix the stator coil 4 to the stator core 30.

A description will now be given of the electric rotary machine 1 having the stator coil 4 and the stator core 30 to which the coil fixing members 5 are assembled.

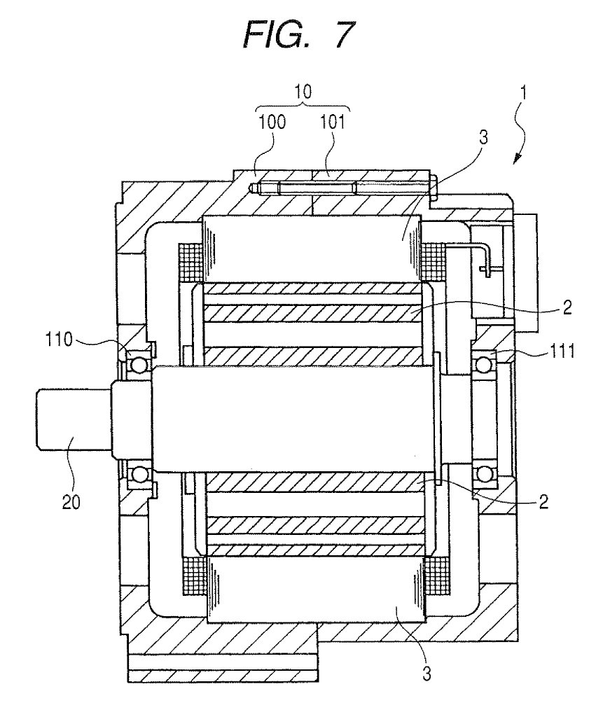

FIG. 7 is a cross section of the electric rotary machine 1 having the stator core 30 and the stator coil 4 to which the coil fixing members 5 are assembled.

As shown in FIG. 7, the electric rotary machine 1 is comprised of the housing 10, the rotor 2, and the stator 3. The housing 10 has a pair of housing members 100 and 101 of a cylindrical shape having one bottom base. The housing members 100 and 101 are joined together through opening parts thereof and tightly fixed to each other. The rotor 2 is fixed to the rotary shaft 20 that is supported by the housing 10 through bearings 110 and 111. The stator 3 is fixed to the housing 10 at the position of the rotor 2 accommodated by the housing 10.

The rotor 2 has a plurality of permanent magnets which are alternately placed along the outer periphery of the rotor 2 in its circumferential direction in order to form different magnetic poles, north (N) pole and south (S) pole. Those magnetic poles face the inner circumferential side of the stator 3. However, the number of the magnetic poles of the rotor 2 is not limited because the electric rotary machines have different number of the magnetic poles according to applications. The structure of the electric rotary machine 1 shown in FIG. 7 has the stator of eight magnetic poles (four N poles and four S poles).

The stator 3 has the stator core 30, the three phase coil 4 composed of phase windings, and insulating sheets (not shown) placed between the stator core 30 and the stator coil 4.

The stator core 30 has a circular ring shape in which a plurality of slots 31 (see FIG. 4) is formed along the inner circumference thereof. each slot 31 is formed so that its depth direction is equal to its diameter direction of the stator core 30. The number of the slots 31 formed in the stator core 30 is two per each phase of the coil 4. That is, the total number of the slots 31 is forty eight (eight poles×three phases×2=48).

The stator core 30 has a predetermined number of divided cores placed along the circumferential direction thereof. In the structure of the electric rotary machine 1 according to the embodiment, its number is twenty four. Each divided core divides one slot 31. That is, the adjacent divided cores observed along the circumferential direction of the stator core 30 forms one slot 31. Each divided core is composed of a teeth part extending toward the inner diameter direction and a back core part where the teeth part is formed.

The stator core 30 is made of four hundred and ten magnetic steel sheets which are laminated. Each magnetic steel sheet has 0.3 mm thickness. The insulation thin film is formed between the adjacent magnetic steel sheets which are laminated. It is also possible to form the stator core 30 using available metal thin-plates and insulation films instead of the above laminated magnetic steel sheets.

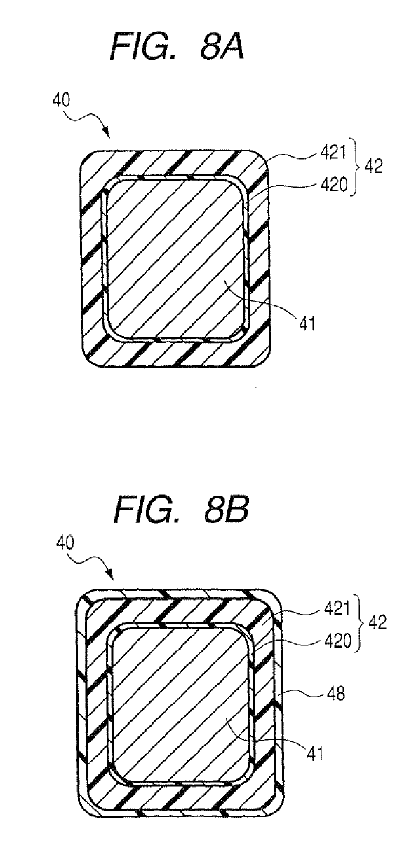

FIG. 8A and FIG. 8B each shows a cross section of each phase winding that forms the stator coil 4 of the electric rotary machine 1 according to the embodiment of the present invention;

The stator coil 4 is formed by winding a plurality of windings 40 in a predetermined direction. As shown in FIG. 8A, each winding 40 forming the stator coil 4 is composed of a conductor 41 made of copper and an insulation film 42. The insulation film 42 is composed of an inner layer 420 and an outer layer 421. The outer periphery of the conductor 41 is covered with the inner layer 420. Thus, the inner layer 420 insulates the conductor 41 from the outer layer 421.

The total thickness of the insulation film 42 composed of the inner layer 420 and the outer layer 421 has a thickness within a range of 100 μm to 200 μm.

Because the insulation film 42 composed of the inner layer 420 and the outer layer 421 is thick, it is not necessary to insulate the winding 40 from the adjacent winding 40 by an insulator such as an insulation paper between the adjacent windings 40. However, it is possible to use the insulation paper between the adjacent windings 40 or between the stator core 30 and the windings 40.

The outer layer 421 is made of insulator such as thermoplastic resin or polyamideimide having a higher glass transition temperature rather than that of the outer layer 421. Using of the above outer layer 421 causes faster softening of the outer layer 421 rather than the inner layer 420 by heat energy generated in the electric rotary machine 1. The heat energy from the electric rotary machine 1 melts the outer layers 421 of the windings 40 placed in the same slot 31 and the outer layers 421 of the windings 40 in the same slot 31 thermally adhere together. The melted outer layers 421 make the single rigid wire composed of the assembled windings 40. As a result, because this increases the mechanical strength of the windings 40 placed in each slot 31, and because the outer layer 421 is firstly separated from the inner layer 420 rather than that the inner layer 420 is separated from the conductor 41 by excess vibration, it is possible to maintain the adhesion force between the inner layer 420 and the conductor 41 in each winding 40, and to maintain the electrical insulation between the conductor 41.

Still further, as shown in FIG. 8A and FIG. 8B, it is possible to cover the outer periphery of the insulation film 42 composed of the inner layer 420 and the outer layer 421 with melting material 43 such as epoxy resin.

Because this structure melts the melting material 43 by heat energy generated in the electric rotary machine 1 faster than the insulation film 42, the plurality of windings 40 placed in the same slot 31 is melted and adhered to each other. This makes the single rigid wire composed of the assembled windings 40. As a result, because this increases the mechanical strength of the windings 40 placed in each slot 31.

Still further, it is possible to use the insulation film 42 made of polyphenylenesulfide (PPS) for the windings 40 forming the stator coil 4.

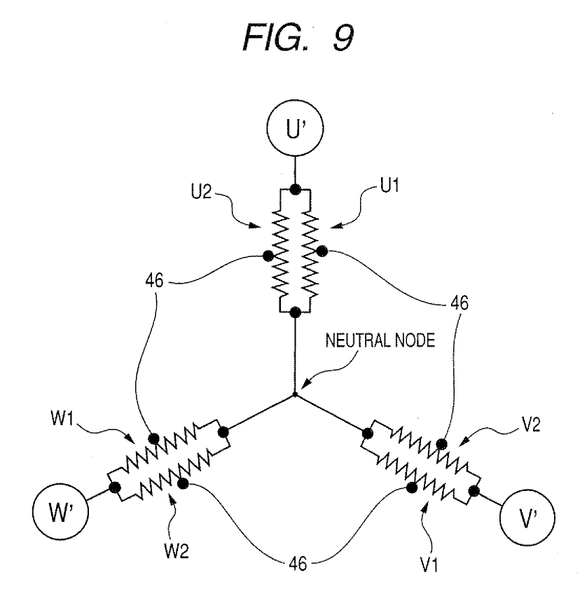

FIG. 9 is a view showing a star connection (Y-connection) of the three phase (U, V, and W phases) windings in the electric rotary machine 1 according to the embodiment of the present invention.

As shown in FIG. 9, the stator coil 4 consists of the three phase windings. Each phase winding is composed of two components such as U1 and U2, V1 and V2, and W1 and W2.

The stator coil 4 consists of the plurality of windings 40 wound in a predetermined loop shape. The windings 40 forming the stator coil 4 are wound at the inner periphery of the stator core 30 along the circumferential direction. The stator core 4 has slot accommodation parts 44 and connection parts 45. Each slot accommodation part 44 has a straight shape and is placed in the slot 31 formed in the stator core 30. Each connection part 45 connects the adjacent slot accommodation parts 44 together.

Each slot accommodation part 44 is accommodated in the slot 31 every predetermined slot number. In the structure of the embodiment, the predetermined slot number is six (three phases×two=six).

Each connection part 45 is projected from the end surface of the stator core 30 in the axial direction of the electric rotary machine 1.

As shown in FIG. 4, FIG. 5, and FIG. 6, the stator coil 4 consists of the plurality of windings 40 formed along the circumferential direction of the stator core 30 so that one end of each winding 40 projects from the end surface of the stator core 30 and has a wave form.

The windings 40 of the stator coil 4 are wound from the outside toward the inside direction of the diameter of the stator core 30.

The end part of each winding 40 projects at the inner circumferential surface from the end surface of the stator coil 4.

The method of winding up the windings 40 of the stator coil 4 is specifically limited.

It is possible to make one phase of the stator coil 4 using two windings 40 which are wound in different direction and have a wave form along the circumferential direction of the stator core 30, and which are connected together at the returning point 46 shown in FIG. 4, FIG. 5, and FIG. 6. That is, it is acceptable for the winding 40 to consist of the primary winding 40 and the secondary winding 40 electrically connected together. Both the slot accommodation parts 44 for the primary and secondary windings are accommodated in the same slot 31. The slot accommodation part 44 for the primary winding 40 and the slot accommodation part 44 for the secondary winding 40 are alternately placed in the depth direction of the slot 31. Because this structure avoids the end part of the winding 40 at the inmost periphery side of the stator coil 4, and the end part of each winding 40 is not thereby over the end surface of the stator coil 4, it is possible to reduce the entire size of the stator coil 4.

The end parts of the primary and secondary windings 40 at the inmost periphery side in the stator coil 4 are electrically connected so that both the primary and secondary windings 40 form one phase. The six pairs of the primary and secondary windings 40 form the stator coil 4 of the three phase (U, V, and W)×two slots. That is, the stator coil 4 uses two windings 40 (primary and secondary windings 40)×three phases (U, V, and W)×two slots=12 (windings in total).

In the embodiment of the present invention, the winding 40 is wound four-times to form the stator coil 4. That is, the stator coil 4 has the four layer structure in the circumferential direction. In other words, the eight slot accommodation parts 44 are placed in one slot 31.

The connection parts 45 of the windings 40 are placed at both sides of the stator core 30 in the axial direction. It is so formed that a central part of the connection part 45 has a crank shape without twisting. The connection part 45 has a crank shape observed along the circumferential direction of the stator core 30. The shift amount of the connection part 45 having the crank shape is approximately equal to a width of the winding 40. Because this structure avoids any interference between the connection parts 45 of the adjacent windings 40 in the diameter direction of the stator core 3, it is possible to closely wind up the connection parts 45 in the stator coil 4.

As a result, because the width of the coil end projected from the end surface of the stator core 30 is reduced, it is possible to avoid the winding 40 forming the stator coil 4 extending toward the outside in the diameter direction of the stator core 30.

The connection part 45 projected from the slot 31 toward the outside of the stator core 30 has a step shape from the end surface of the stator core 30 toward the axial direction of the stator core 30. Having the step shape of the connection part 45 avoids the interference to the winding 40 projecting from the slot which is adjacent to the connection part 45 along the circumferential direction. This structure prevents the height of the coil end projecting from the end surface of the stator core 30 or the width of the coil end in the diameter direction becoming large in order to eliminate interference between windings together projecting from the slots adjacent along the circumferential direction. As a result, because the height of the coil ends of the stator coil 4 can be decreased, and the width of the coil end of the stator coil 4 in the diameter direction of the stator core 30 becomes small, it is possible to prevent the stator coil 4 from projecting toward the diameter direction of the stator core 30.

The connection part 45 has the four step shape, and the height of one step of the connection part 45 is approximately equal to the width (or height) of the winding 40. It is thereby possible to overlap the connection parts 45 without any gap when the connection parts 45 are laminated in the axial direction of the stator core 30. This structure of the connection parts 45 allows the connection parts 45 to be closely wound.

The top part (or the highest part) of the step-shaped connection part 45 has a crank-shaped part. Therefore both sides of the connection part 45 of the winding 40 have the step shape toward both sides observed from the crank-shaped part.

There is a gap between the bottom part of the connection part 45 of a step shape and the end surface of the stator core 30. The bottom part of the connection part 45 is a part extending approximately in parallel along the end surface of the stator core 30. The gap relaxes the stress applied to the stator windings 40 when the windings 40 are processed, the stator coil 4 and the stator core 30 are assembled. The presence of the gap also prevents deterioration of the insulation function, and also the stator core 30 from being deformed.

In the stator coil 4, the connection parts 45 project within the height of the coil end projected from the stator core 30, and the end part of the assembled body of each winding 40 forming the stator coil 4 projects toward the outside of the diameter direction of the stator core 30. The end part of each assembled phase winding 40, that is, the end part of the neutral node of the stator coil 4 projects toward the outside in the diameter direction rather than the end part of the other windings.

The present invention does not limit the number of the coil fixing members 5 to be assembled in the electric rotary machine 1. It is acceptable to fix the coil fixing members 5 at not less than a pair of symmetric positions along the circumferential direction of the stator core 30. The most preferable number thereof is three.

Still further, it is sufficient to fix the coil fixing members 5 onto at least one end surface of the stator core 30 in the electric rotary machine 1. It is more preferable to fix the coil fixing members 5 onto both the end surface of the stator core 30 in the electric rotary machine 1.

### (Other Features and Effects of the Present Invention)

In the coil fixing member as another aspect of the present invention the secondary fixing member has a lock part. The lock part locks the outermost peripheral surface of the connection part of the winding of the stator coil in the diameter direction. The secondary fixing member is also locked by the connection part of the winding of the stator coil. This prevents the secondary fixing member from shifting toward the diameter direction of the stator core.

In the coil fixing member as another aspect of the present invention, the primary fixing member suppresses the secondary fixing member from shifting toward the outside of the diameter direction of the stator core. The stopper part of the primary fixing member prevents the secondary fixing member from shifting toward the outside of the diameter direction of the stator core.

In accordance with another aspect of the present invention, an electric rotary machine has a rotor, a stator, a stator coil, and coil fixing members. The rotor has a plurality of magnetic north and south poles, alternately placed along the circumferential direction thereof. The stator core has a plurality of slots formed on at least one end surface thereof along the circumferential direction. The stator coil has stator windings. Each stator winding has connection parts. Each connection part connects slot accommodation parts together at the outside of the slot. The slot accommodation parts are placed in different slots in the circumferential direction. A plurality of coil fixing members are placed between the stator coil and at least one end surface of the stator core in order to suppress a displacement between the stator coil and the stator core. Each coil fixing member has a primary fixing member and a secondary fixing member. The primary fixing member of a wedge-plate shape has a support part at one side of the circumferential direction of the stator core. The primary fixing member is inserted from the outer side of the diameter direction of the stator core toward the inner side thereof between the connection parts of the windings of the stator coil and the end surface of the stator core. The support part is capable of supporting the connection part of the winding of the stator core. The secondary fixing member of a rod shape is placed at the other side of the primary fixing member The secondary fixing member is inserted from the inner side of the diameter direction of the stator core toward the outer side thereof between the connection parts of the windings of the stator coil and the end surface of the stator core.

The coil fixing members make it hard to fall away of or release the stator core even if various types of stress such as mechanical stress, heat stress, and vibration are applied to the coil fixing members and those stresses deform the coil fixing members placed between the stator coil and the end surface of the stator core. That is, the electric rotary machine with the coil fixing members has the improved feature to avoid decreasing of the performance caused by falling away of the coil fixing members from the stator core.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A coil fixing member to be placed between a stator coil and at least one end surface of a stator core in an electric rotary machine having a rotor with a plurality of magnetic north and south poles alternately placed along the circumferential direction thereof, each coil fixing member suppressing a displacement between the stator core and the stator coil and fixing them together, the stator core having a plurality of slots formed along the circumferential direction of the stator core, the direction in depth of each slot being equal to the diameter direction of the stator core, the slots facing together at the inside or the outside, the stator coil comprising stator windings, each stator winding having connection parts, each connection part connecting the stator windings in slot accommodation parts together at the outside of the slots, and the slot accommodation parts being placed in different slots in the circumferential direction of the stator core,
each coil fixing member comprising:
a primary fixing member of a wedge-plate shape having a support part at one side of the circumferential direction of the stator core, to be inserted from the outer side of the diameter direction of the stator core toward the inner side thereof between the connection parts of the windings of the stator coil and the end surface of the stator core, and the support part being capable of supporting the connection part of the winding of the stator core; and
a secondary fixing member of a rod shape having a lock part placed at the other side of the primary fixing member, to be inserted from the inner side of the diameter direction of the stator core toward the outer side thereof between the connection parts of the windings of the stator coil and the end surface of the stator core.

2. The coil fixing member according to claim 1, wherein the secondary fixing member having a lock part, and the lock part locks the outermost peripheral surface of the connection part of the winding of the stator coil in the diameter direction.

3. The coil fixing member according to claim 1, wherein the primary fixing member suppresses the secondary fixing member from shifting toward the outside of the diameter direction of the stator core.

4. The coil fixing member according to claim 2, wherein the primary fixing member suppresses the secondary fixing member from shifting toward the outside of the diameter direction of the stator core.

5. An electric rotary machine comprising:
a rotor having a plurality of magnetic north and south poles, is alternately placed along the circumferential direction thereof;
a stator core having a plurality of slots formed on at least one end surface thereof along the circumferential direction;
a stator coil comprising stator windings, each stator winding having connection parts, each connection part connecting slot accommodation parts together at the outside of the slot, and the slot accommodation parts being placed in different slots in the circumferential direction; and
a plurality of coil fixing members placed between the stator coil and at least one end surface of the stator core in order to suppress a displacement between the stator coil and the stator core,
each coil fixing member comprising:
a primary fixing member of a wedge-plate shape having a support part at one side of the circumferential direction of the stator core, to be inserted from the outer side of the diameter direction of the stator core toward the inner side thereof between the connection parts of the windings of the stator coil and the end surface of the stator core, and the support part being capable of supporting the connection part of the winding of the stator core; and
a secondary fixing member of a rod shape placed at the other side of the primary fixing member, to be inserted from the inner side of the diameter direction of the stator core toward the outer side thereof between the connection parts of the windings of the stator coil and the end surface of the stator core.
